(19) United States
(12) Patent Application Publication
(10) Pub. No.: US 2021/0090551 A1
(43) Pub. Date: Mar. 25, 2021

(54) EMOTIONAL SPEECH GENERATING METHOD AND APPARATUS FOR CONTROLLING EMOTIONAL INTENSITY

(71) Applicants: Electronics and Telecommunications Research Institute, Daejeon (KR); Industry-Academic Cooperation Foundation, Yonsei University, Seoul (KR)

(72) Inventors: Inseon JANG, Daejeon (KR); Hong-Goo KANG, Seoul (KR); Chung Hyun AHN, Daejeon (KR); Se-Yun UM, Seoul (KR); Sangshin OH, Seoul (KR); Tae Jin LEE, Daejeon (KR)

(73) Assignees: Electronics and Telecommunications Research Institute, Daejeon (KR); Industry-Academic Cooperation Foundation, Yonsei University, Seoul (KR)

(21) Appl. No.: 17/029,960

(22) Filed: Sep. 23, 2020

(30) Foreign Application Priority Data
Sep. 23, 2019 (KR) 10-2019-0116863
Nov. 4, 2019 (KR) 10-2019-0139691
Aug. 28, 2020 (KR) 10-2020-0109402

(51) Int. Cl. G10L 13/08; G10L 25/63; G10L 13/033

(52) U.S. Cl. CPC G10L 13/08; G10L 13/033; G10L 25/63

(57) ABSTRACT

An emotional speech generating method and apparatus capable of adjusting an emotional intensity is disclosed. The emotional speech generating method includes generating emotion groups by grouping weight vectors representing a same emotion into a same emotion group, determining an internal distance between weight vectors included in a same emotion group, determining an external distance between weight vectors included in a same emotion group and weight vectors included in another emotion group, determining a representative weight vector of each of the emotion groups based on the internal distance and the external distance, generating a style embedding by applying the representative weight vector of each of the emotion groups to a style token including prosodic information for expressing an emotion, and generating an emotional speech expressing the emotion using the style embedding.

### CROSS-REFERENCE TO RELATED APPLICATION(S)

This application claims the priority benefit of Korean Patent Application No. 10-2019-0116863 filed on Sep. 23, 2019, Korean Patent Application No. 10-2019-0139691 filed on Nov. 4, 2019, and Korean Patent Application No. 10-2020-0109402 filed on Aug. 28, 2020, in the Korean Intellectual Property Office, the disclosures of which are incorporated herein by reference for all purposes.

### BACKGROUND

### 1. Field

One or more example embodiments relate to an emotional speech generating method and apparatus, and more particularly, to a method and apparatus that generates an emotional speech in which emotional intensity of an emotion is controlled among emotions.

### 2. Description of Related Art

An end-to-end text-to-speech (TTS) system receives a text and synthesizes a natural speech that sounds similar to a human utterance from the received text.

To express an emotion loaded in a human utterance, an emotional speech generating method has been developed. The existing emotional speech generating method applies, to an end-to-end TTS system, an additional architecture for modeling a speech change over time using prosody as a latent variable based on a characteristic that the expression of an emotion is closely associated with prosody of a speech.

Here, a style token architecture is used. The style token architecture generates a style embedding with a weighted sum of a global style token (GST) including prosodic information, and applies the generated style embedding to a style of a synthetic speech by inputting the style embedding in a form of a condition vector to the end-to-end T'S system.

However, since the existing emotional speech generating method selects, as a representative weight vector of a corresponding emotion, a mean value of weight vectors representing the same emotion, it may not be a guaranteed optimal way to express the emotion corresponding to the mean value of the weight vectors to be explicitly distinguishable from other emotions.

In addition, since the existing emotional speech generating method selects one of representative weight vectors to generate an emotional speech, it may generate the emotional speech only with one of preset emotions and may not express a complex emotion or an emotional intensity.

Thus, there is a desire for a method of selecting a representative weight vector of an emotion such that the emotion is distinguishable from another emotion, or a method of expressing a complex emotion or an emotional intensity.

### SUMMARY

An aspect provides a method and apparatus that generates an emotional speech explicitly expressing an emotion by measuring an internal distance in a group and an external distance with another group, selecting a representative weight vector for each emotion, generating a style embedding based on the selected representative weight vector, and inputting the generated style embedding to an end-to-end speech synthesis system.

Another aspect provides a method and apparatus that controls an intensity of a target emotion by generating a new emotion group by linearly interpolating a representative weight vector of a neutral emotion group and a target emotion group, and then generating a style embedding by selecting a representative weight vector of the new emotion group.

Still another aspect provides a method and apparatus that expresses a new emotion absent from given emotion data by generating a new emotion group by linearly interpolating a representative weight vector and another emotion group based on a nonlinear interpolation ratio that is based on a standard deviation between two source emotion groups, and then generating a style embedding by selecting a representative weight vector of the new emotion group.

According to an example embodiment, there is provided an emotional speech generating method including generating emotion groups by grouping weight vectors representing a same emotion into a same emotion group, determining an internal distance which is a distance between weight vectors included in a same emotion group, determining an external distance which is a distance between weight vectors included in a same emotion group and weight vectors included in another emotion group, determining a representative weight vector of each of the emotion groups based on the internal distance and the external distance, generating a style embedding by applying the representative weight vector to a style token including prosodic information for expressing an emotion, and generating an emotional speech expressing the emotion using the style embedding.

The representative weight vector may be a weight vector having a smallest sum of internal distances and a greatest sum of external distances among weight vectors included in each of the emotion groups.

The emotional speech generating method may further include receiving a text, and determining a text emotion which is an emotion corresponding to the text by analyzing the text. The generating of the style embedding may include generating the style embedding using a representative weight vector of a text emotion group corresponding to the text emotion among the emotion groups.

According to another example embodiment, there is provided an emotional speech generating method including generating emotion groups by grouping weight vectors representing a same emotion into a same emotion group, identifying, from among the emotion groups, a neutral emotion group corresponding to a neutral emotion and a target emotion group corresponding to an emotion to be expressed in an emotional speech, generating a new emotion group with an emotional intensity adjusted from the target emotion group by using a representative weight vector of the neutral emotion group and the target emotion group, determining a representative weight vector of the new emotion group based on an internal distance between weight vectors included in the new emotion group, and an external distance between the weight vectors included in the new emotion group and weight vectors included in the neutral emotion group or the target emotion group, generating a style embedding by applying the representative weight vector of the new emotion group to a style token including prosodic information for expressing an emotion, and generating the emotional speech expressing the emotion using the style embedding.

The generating of the new emotion group may include generating new weight vectors by interpolating, at a nonlinear interpolation ratio, the representative weight vector of the neutral emotion group and the weight vectors included in the target emotion group, and generating the new emotion group by grouping the generated new weight vectors.

The emotional speech generating method may further include receiving a text, and determining an emotional intensity corresponding to the text by analyzing the text. The generating of the new emotion group may include determining the nonlinear interpolation ratio based on the emotional intensity.

The representative weight vector of the neutral emotion group may be determined based on an internal distance between the weight vectors included in the neutral emotion group, and an external distance between the weight vectors included in the neutral emotion group and weight vectors included in another emotion group.

The representative weight vector of the neutral emotion group may be a weight vector having a smallest sum of internal distances and a greatest sum of external distances among the weight vectors included in the neutral emotion group.

The emotional speech generating method may further include receiving a text, and determining a text emotion which is an emotion corresponding to the text by analyzing the text. The identifying of the target emotion group may include identifying, as the target emotion group, an emotion group representing the text emotion from among the emotion groups.

The representative weight vector of the new emotion group may be a weight vector having a smallest sum of internal distances and a greatest sum of external distances among the weight vectors included in the new emotion group.

According to still another example embodiment, there is provided an emotional speech generating method including generating emotion groups by grouping weight vectors representing a same emotion into a same emotion group, identifying, from among the emotion groups, target emotion groups respectively corresponding to emotions mixed in a target emotion to be expressed in an emotional speech, generating a new emotion group corresponding to the target emotion using the target emotion groups, determining a representative weight vector of the new emotion group based on an internal distance between weight vectors included in the new emotion group and an external distance between the weight vectors included in the new emotion group and weight vectors included in each of the target emotion groups, generating a style embedding by applying the representative weight vector of the new emotion group to a style token including prosodic information for expressing an emotion, and generating the emotional speech expressing the emotion using the style embedding.

The generating of the new emotion group may include generating an adjusted emotion group with an adjusted emotional intensity by using a representative weight vector of a neutral emotion group corresponding to a neutral emotion and one of the target emotion groups, interpolating weight vectors included in the target emotion groups based on a nonlinear interpolation ratio and then generating new weight vectors by applying the adjusted emotion group, and generating the new emotion group by grouping the new weight vectors.

According to yet another example embodiment, there is provided an emotional speech generating apparatus including an emotion vector generator and an emotional speech generator. The emotion vector generator may generate emotion groups by grouping weight vectors representing a same emotion into a same emotion group, identify, from among the emotion groups, a neutral emotion group corresponding to a neutral emotion and a target emotion group corresponding to an emotion to be expressed in an emotional speech, generate a new emotion group with an emotional intensity adjusted from the target emotion group by using a representative weight vector of the neutral emotion group and the target emotion group, determine a representative weight vector of the new emotion group based on an internal distance between weight vectors included in the new emotion group and an external distance between the weight vectors included in the new emotion group and weight vectors included in the neutral emotion group or the target emotion group, and generate a style embedding by applying the representative weight vector of the new emotion group to a style token including prosodic information for expressing an emotion. The emotional speech generator may generate an emotional speech expressing the emotion using the style embedding.

The emotion vector generator may generate new weight vectors by interpolating the representative weight vector of the neutral emotion group and the weight vectors included in the target emotion group based on a nonlinear interpolation ratio, and generate the new emotion group by grouping the generated new weight vectors.

The emotional speech generating apparatus may further include an emotion identifier configured to receive a text, and determine an emotional intensity corresponding to the text by analyzing the text. The emotion vector generator may determine the nonlinear interpolation ratio based on the determined emotional intensity.

The representative weight vector of the neutral emotion group may be determined based on an internal distance between the weight vectors included in the neutral emotion group and an external distance between the weight vectors included in the neutral emotion group and weight vectors included in another emotion group.

According to further another example embodiment, there is provided an emotional speech generating apparatus including an emotion vector generator and an emotional speech generator. The emotion vector generator may generate emotion groups by grouping weight vectors representing a same emotion into a same emotion group, identify, from among the emotion groups, target emotion groups respectively corresponding to emotions mixed in a target emotion to be expressed in an emotional speech, generate a new emotion group corresponding to the target emotion using the target emotion groups, determine a representative weight vector of the new emotion group based on an internal distance between weight vectors included in the new emotion group and an external distance between the weight vectors included in the new emotion group and weight vectors included in each of the target emotion groups, and generate a style embedding by applying the representative weight vector of the new emotion group to a style token including prosodic information for expressing an emotion. The emotional speech generator may generate the emotional speech expressing the emotion using the style embedding.

The emotion vector generator may generate an adjusted emotion group with an adjusted emotional intensity by using a representative weight vector of a neutral emotion group corresponding to a neutral emotion and one of the target emotion groups, interpolate weight vectors included in the target emotion groups based on a nonlinear interpolation ratio and then generate new weight vectors by applying the adjusted emotion group, and then generate the new emotion group by grouping the new weight vectors.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a diagram illustrating an emotional speech generating apparatus according to an example embodiment;

FIG. 2 is a flowchart illustrating an emotional speech generating method according to an example embodiment;

FIG. 3 is a flowchart illustrating an emotional speech generating method according to another example embodiment; and

FIG. 4 is a flowchart illustrating an emotional speech generating method according to still another example embodiment.

### DETAILED DESCRIPTION

Hereinafter, some examples will be described in detail with reference to the accompanying drawings. However, various alterations and modifications may be made to the examples. Here, the examples are not construed as limited to the disclosure and should be understood to include all changes, equivalents, and replacements within the idea and the technical scope of the disclosure.

The terminology used herein is for the purpose of describing particular examples only and is not to be limiting of the examples. As used herein, the singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

When describing the examples with reference to the accompanying drawings, like reference numerals refer to like constituent elements and a repeated description related thereto will be omitted. In the description of examples, detailed description of well-known related structures or functions will be omitted when it is deemed that such description will cause ambiguous interpretation of the present disclosure.

Hereinafter, example embodiments will be described in detail with reference to the accompanying drawings.

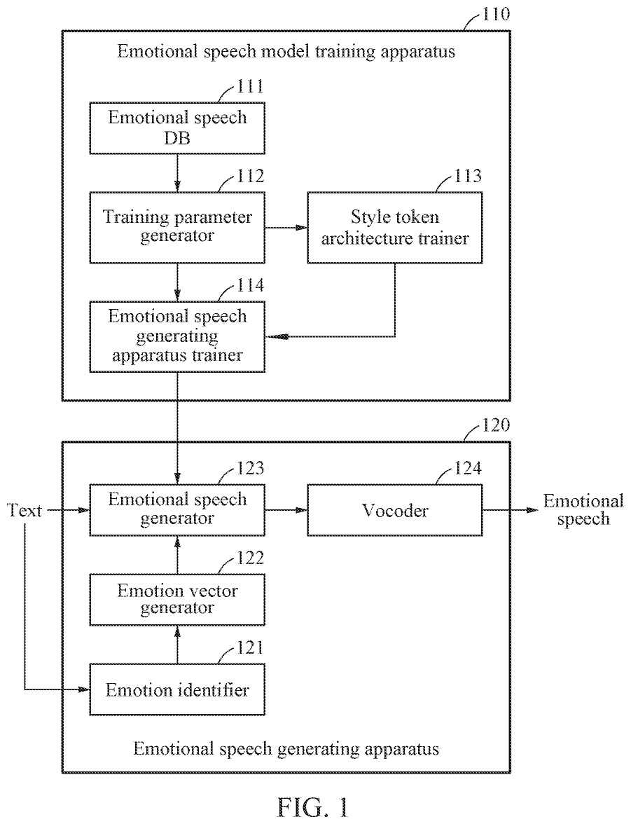

FIG. 1 is a diagram illustrating an emotional speech generating apparatus according to an example embodiment.

Referring to FIG. 1, an emotional speech model training apparatus 110 includes an emotional speech database (DB) 111, a training parameter generator 112, a style token architecture trainer 113, and an emotional speech generating apparatus trainer 114. The emotional speech DB 111 may be a storage medium. The training parameter generator 112, the style token architecture trainer 113, and the emotional speech generating apparatus trainer 114 may be different processors, or modules included in a program performed in a single processor.

The emotional speech DB 111 may store and manage a text and speech information corresponding to the text. The emotional speech DB 111 may transmit the text and the speech information corresponding to the text to the training parameter generator 112.

The training parameter generator 112 may generate parameters to train the emotional speech generating apparatus trainer 114 and the style token architecture trainer 113 using the text and preprocessed speech information corresponding to the text. Among the parameters generated by the training parameter generator 112, target data of an emotional speech generating apparatus 120 may be a Mel-spectrogram of reference audio.

The style token architecture trainer 113 may train a style token architecture using such a training parameter.

In detail, the style token architecture trainer 113 may receive the Mel-spectrogram of the reference audio from the training parameter generator 112. The style token architecture trainer 113 may then generate a reference embedding into which prosodic information is compressed, using the Mel-spectrogram of the reference audio. The style token architecture trainer 113 may then train a weight vector and a style token vector using an attention module.

The style token architecture trainer 113 may generate a style embedding by applying the weight vector to the style token. For example, the style token architecture trainer 113 may generate the style embedding by multiplying the style token by the weight vector. The style token architecture trainer 113 may then input, to the emotional speech generating apparatus trainer 114, the style embedding along with the input text.

The emotional speech generating apparatus trainer 114 may train the emotional speech generating apparatus 120 using such a training parameter. In detail, a transcript encoder (not shown) may receive the input text. The input text may be the text matching the reference audio.

The transcript encoder may generate a transcript embedding based on the input text and transmit the generated transcript embedding to the emotional speech generating apparatus trainer 114.

The emotional speech generating apparatus trainer 114 may predict the Mel-spectrogram of the reference audio by using the style embedding received from the style token architecture trainer 113 and the transcript embedding. For example, the emotional speech generating apparatus trainer 114 may concatenate the style embedding and the transcript embedding, input a result of the concatenating to a decoder, and output a predicted Mel-spectrogram.

The emotional speech generating apparatus trainer 114 may then calculate a mean squared error (MSE) loss by comparing the predicted Mel-spectrogram of the reference audio to an original Mel-spectrogram of the reference audio that is stored in the emotional speech DB 111.

The emotional speech generating apparatus trainer 114 may update the weight vector such that the calculated MSE loss is reduced. In such a case, the emotional speech generating apparatus trainer 114 may repeat the process described above until the MSE loss is minimized. When the MSE loss becomes less than or equal to a preset threshold value, the emotional speech generating apparatus trainer 114 may determine that the MSE loss is minimized and then terminate training an emotional speech model.

The emotional speech generating apparatus 120 includes an emotion identifier 121, an emotion vector generator 122, an emotional speech generator 123, and a vocoder 124. The emotion identifier 121, the emotion vector generator 122, the emotional speech generator 123, and the vocoder 124 may be different processors, or modules included in a program performed in a single processor. In addition, the emotional speech generator 123 may be provided in an integral form with the emotional speech generating apparatus trainer 114.

The emotion identifier 121 may receive a text. The emotion identifier 121 may then determine a text emotion which is an emotion corresponding to the text by analyzing the received text. In addition, the emotion identifier 121 may determine an emotional intensity corresponding to the text by analyzing the received text. Depending on examples, the emotional speech generating apparatus 120 may not include the emotion identifier 121. In such a case, the emotion vector generator 122 may receive, from a user, the text emotion and the emotional intensity corresponding to the text.

The emotion vector generator 122 may extract a weight vector of a style embedding for each emotion from the model trained by the style token architecture trainer 113.

Here, vectors representing a same emotion among trained weight vectors may have a similar characteristic, and thus may constitute a same group in an embedding space. Thus, the emotion vector generator 122 may generate emotion groups by grouping weight vectors representing a same emotion into a same emotion group.

The emotion vector generator 122 may determine an internal distance which is a distance between weight vectors included in the same emotion group. In addition, the emotion vector generator 122 may determine an external distance which is a distance between the weight vectors included in the same emotion group and weight vectors included in a different emotion group.

The emotion vector generator 122 may then determine a representative weight vector of each of the emotion groups based on the internal distance and the external distance. The representative weight vector may be a weight vector having a smallest sum of internal distances and a greatest sum of external distances among weight vectors included in an emotion group.

The emotion vector generator 122 may generate a style embedding by applying the representative weight vector to a style token including prosodic information for expressing an emotion. Here, the emotion vector generator 122 may generate the style embedding using a representative weight vector of a text emotion group corresponding to a text emotion among the emotion groups.

The emotion vector generator 122 may transmit the style embedding to the emotional speech generator 123.

In addition, the emotion vector generator 122 may control or adjust an intensity of a target emotion using a neutral emotion group and a target emotion group corresponding to an emotion to be expressed in an emotional speech.

In detail, the emotion vector generator 122 may identify, from among the emotion groups, the neutral emotion group corresponding to a neutral emotion and the target emotion group corresponding to the emotion to be expressed in the emotional speech. The emotion vector generator 122 may identify, as the target emotion group, an emotion group representing a text emotion among the emotion groups.

The emotion vector generator 122 may then generate a new emotion group with an emotional intensity adjusted from that of the target emotion group by using a representative weight vector of the neutral emotion group and the target emotion group. In such a case, the emotion vector generator 122 may generate new weight vectors by interpolating the representative weight vector of the neutral emotion group and weight vectors included in the target emotion group based on a nonlinear interpolation ratio, and generate the new emotion group by grouping the new weight vectors. The nonlinear interpolation ratio may be determined based on an emotional intensity corresponding to a text.

The representative weight vector of the neutral emotion group may be determined based on an internal distance between weight vectors included in the neutral emotion group and an external distance between the weight vectors included in the neutral emotion group and weight vectors included in a different emotion group. For example, the representative weight vector of the neutral emotion group may be a weight vector having a smallest sum of internal distances and a greatest sum of external distances among the weight vectors included in the neutral emotion group.

The emotion vector generator 122 may then determine a representative weight vector of the new emotion group based on an internal distance between the weight vectors included in the new emotion group and an external distance between the weight vectors included in the new emotion group and the weight vectors included in the neutral emotion group or the target emotion group. For example, the representative weight vector of the new emotion group may be a weight vector having a smallest sum of internal distances and a greatest sum of external distances among the weight vectors included in the new emotion group.

The emotion vector generator 122 may then generate a style embedding by applying the representative weight vector of the new emotion group to a style token.

In addition, the emotion vector generator 122 may generate an emotional speech expressing a target emotion in which a plurality of emotions is mixed by using a plurality of emotion groups.

In detail, the emotion vector generator 122 may identify, from among the emotion groups, target emotion groups respectively corresponding to the emotions mixed in the target emotion.

The emotion vector generator 122 may then generate a new emotion group corresponding to the target emotion by using the identified target emotion groups. In such a case, the emotion vector generator 122 may generate an adjusted emotion group in which an emotional intensity is adjusted by using a representative weight vector of a neutral emotion group corresponding to a neutral emotion and one of the target emotion groups. The emotion vector generator 122 may interpolate weight vectors included in the target emotion groups at a nonlinear interpolation ratio, and then generate new weight vectors by applying the adjusted emotion group. The emotion vector generator 122 may then generate the new emotion group by grouping the new weight vectors.

The emotion vector generator 122 may then determine a representative weight vector of the new emotion group based on an internal distance between the weight vectors included in the new emotion group and an external distance between the weight vectors included in the new emotion group and weight vectors included in the neutral emotion group or the target emotion group. For example, the representative weight vector of the new emotion group may be a weight vector having a smallest sum of internal distances and a greatest sum of external distances among the weight vectors included in the new emotion group.

The emotion vector generator 122 may then generate a style embedding by applying the representative weight vector of the new emotion group to a style token.

The emotional speech generator 123 may generate an emotional speech expressing an emotion using the style embedding received from the emotion vector generator 122. For example, the emotional speech generator 123 may be a deep learning-based emotional speech synthesis system in an end-to-end model environment.

In detail, the emotional speech generator 123 may generate a Mel-spectrogram of a speech that corresponds to a content included in a text and expresses an emotion by using the text and the style embedding. The emotional speech generator 123 may then transmit the Mel-spectrogram to the vocoder 124.

The vocoder 124 may generate the emotional speech based on the Mel-spectrogram received from the emotional speech generator 123 and output the generated emotional speech.

According to an example embodiment, an emotional speech generating apparatus may select a representative weight vector for each emotion by measuring an internal distance in a group and an external distance with another group to reflect a characteristic of an emotion group of weight vectors representing a same emotion, generate a style embedding based on the selected representative weight vector, and input the generated style embedding to an end-to-end speech synthesis system, thereby generating an emotional speech that explicitly expresses a corresponding emotion.

According to an example embodiment, an emotional speech generating apparatus may generate a new emotion group by linearly interpolating a representative weight vector of a neutral emotion group and a target emotion group, and generate a style embedding by selecting a representative weight vector of the new emotion group, thereby controlling or adjusting an intensity of a target emotion.

According to an example embodiment, an emotional speech generating apparatus may generate a new emotion group by linearly interpolating a representative weight vector and another emotion group based on a nonlinear interpolation ratio that is based on a standard deviation between two source emotion groups, and generate a style embedding by selecting a representative weight vector of the new emotion group, thereby expressing a new emotion absent from given emotion data.

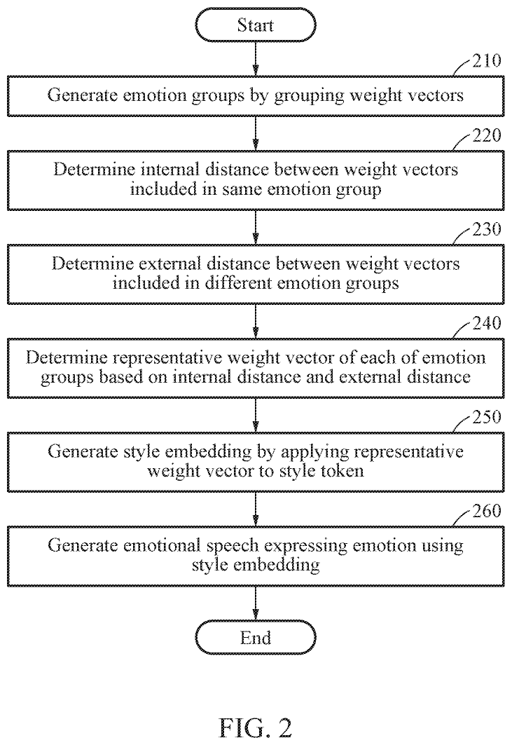

FIG. 2 is a flowchart illustrating an emotional speech generating method according to an example embodiment.

Referring to FIG. 2, in operation 210, the emotion vector generator 122 generates emotion groups by grouping weight vectors representing a same emotion into a same emotion group.

In operation 220, the emotion vector generator 122 determines an internal distance which is a distance between weight vectors included in the same emotion group.

In operation 230, the emotion vector generator 122 determines an external distance which is a distance between the weight vectors included in the emotion group and weight vectors included in a different emotion group.

In operation 240, the emotion vector generator 122 determines a representative weight vector for each of the emotion groups based on the internal distance determined in operation 220 and the external distance determined in operation 230. The representative weight vector may be a weight vector having a smallest sum of internal distances and a greatest sum of external distances among weight vectors included in each of the emotion groups.

For example, a representative weight vector rₑ of an emotion e may satisfy Equation 1 below.

$${r}_{e} = arg {min}_{{x}_{k}} {\sum }_{i = 1}^{I} {D}_{E} ( {x}_{k} , {x}_{i} ) \qquad [ Equation 1 ]$$

In Equation 1, D_{E} denotes a square of a Euclidean distance, and k denotes an emotion index. In addition, I denotes the number of weight vectors included in an emotion group e. xₖ denotes a weight vector, and xᵢ denotes another weight vector included in the emotion group e.

In addition, the representative weight vector rₑ of the emotion e may satisfy Equation 2 below.

$${r}_{e} = arg {max}_{{x}_{k}} {\sum }_{j = 1}^{J} {D}_{E} ( {x}_{k} , {x}_{j} ) \qquad [ Equation 2 ]$$

In Equation 2, J denotes the number of weight vectors included in another emotion group different from the emotion group e. xᵢ denotes a weight vector included in the other emotion group.

That is, the representative weight vector rₑ of the emotion e needs to satisfy both Equations 1 and 2, and thus be represented by Equation 3 below.

$${r}_{e} = arg {max}_{{x}_{k}} \frac{{\sum }_{x ∈ {X}_{\neq e}} {D}_{E} ( {x}_{k} , {x}_{j} )}{{\sum }_{x ∈ {X}_{e}} {D}_{E} ( {x}_{k} , {x}_{i} )} \qquad [ Equation 3 ]$$

In operation 250, the emotion vector generator 122 generates a style embedding by applying the representative weight vector determined in operation 240 to a style token including prosodic information for expressing an emotion. For example, the emotion vector generator 122 may receive, from a user, a text emotion which is an emotion corresponding to a text. In this example, the emotion vector generator 122 may generate the style embedding using a representative weight vector of a text emotion group corresponding to the text emotion among the emotion groups.

For example, the emotion identifier 121 may receive a text. In this example, the emotion identifier 121 may determine a text emotion which is an emotion corresponding to the text by analyzing the received text. The emotion vector generator 122 may then generate the style embedding using a representative weight vector of a text emotion group corresponding to the text emotion among the emotion groups.

In operation 260, the emotional speech generator 123 generates an emotional speech expressing the emotion using the style embedding generated in operation 250.

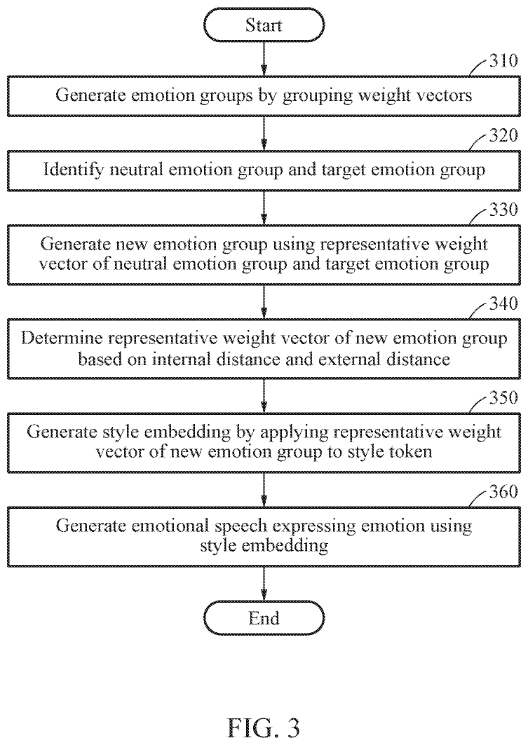

FIG. 3 is a flowchart illustrating an emotional speech generating method according to another example embodiment. The emotional speech generating method to be described hereinafter according to another example embodiment may be an emotional speech generating method that controls or adjusts an intensity of an emotion included in an emotional speech. An intensity of an emotion may also be referred to herein as an emotional intensity.

Referring to FIG. 3, in operation 310, the emotion vector generator 122 generates emotion groups by grouping weight vectors representing a same emotion into a same emotion group.

In operation 320, the emotion vector generator 122 identifies, from among the emotion groups, a neutral emotion group corresponding to a neutral emotion and a target emotion group corresponding to an emotion to be expressed in an emotional speech. The emotion vector generator 122 may receive a target emotion. The emotion vector generator 122 may identify an emotion group corresponding to the target emotion as the target emotion group from among the emotion groups.

Alternatively, the emotion identifier 121 may receive a text. In such a case, the emotion identifier 121 may analyze the received text and determine a text emotion which is an emotion corresponding to the text. The emotion vector generator 122 may then identify an emotion group representing the text emotion as the target emotion group from among the emotion groups.

In operation 330, the emotion vector generator 122 generates a new emotion group having an emotional intensity adjusted from the target emotion group by using a representative weight vector of the neutral emotion group and using the target emotion group. The representative weight vector of the neutral emotion group may be determined based on an internal distance between weight vectors included in the neutral emotion group and an external distance between the weight vectors included in the neutral emotion group and weight vectors included in a different emotion group. For example, the representative weight vector of the neutral emotion group may be a weight vector having a smallest sum of internal distances and a greatest sum of external distances among the weight vectors included in the neutral emotion group.

In addition, the emotion vector generator 122 may generate new weight vectors by interpolating the representative weight vector of the neutral emotion group and weight vectors included in the target emotion group based on a nonlinear interpolation ratio, and generate the new emotion group by grouping the generated new weight vectors. The nonlinear interpolation ratio may be determined based on an intensity of an emotion corresponding to a text. The new emotion group may be an emotion group corresponding to an emotion having a certain intensity, for example, slight anger and strong happiness, instead of a standard emotion such as happiness, sadness, anger, and neutrality.

For example, the emotion vector generator 122 may generate the new weight vectors using Equation 4 below.

gᵢ=α·n+(1−α)·eᵢ [Equation 4]

In Equation 4, gᵢ denotes a new weight vector. n denotes a representative weight vector of a neutral emotion group, and eᵢ denotes a weight vector of a target emotion group which is denoted by E. The target emotion group E is an emotion group corresponding to one of emotions such as anger, happiness, and sadness, and may be indicated by E∈{e₁, . . . eᵢ . . . e_{I}}. In addition, a weight a that is based on a nonlinear interpolation ratio may satisfy 0≤α≤1. For example, when the weight a is closer to 1, an intensity of an emotion included in an emotional speech may increase. When the weight a is closer to 0, the intensity of the emotion included in the emotional speech may decrease.

In operation 340, the emotion vector generator 122 determines a representative weight vector of the new emotion group based on an internal distance between the weight vectors included in the new emotion group generated in operation 330 and an external distance between the weight vectors included in the new emotion group and the weight vectors included in the neutral emotion group or the target emotion group. The representative weight vector of the new emotion group may be a weight vector having a smallest sum of internal distances and a greatest sum of external distances among the weight vectors included in the new emotion group.

In operation 350, the emotion vector generator 122 generates a style embedding by applying the representative weight vector of the new emotion group to a style token including prosodic information for expressing an emotion.

In operation 360, the emotional speech generator 123 generates the emotional speech expressing the emotion using the style embedding generated in operation 350.

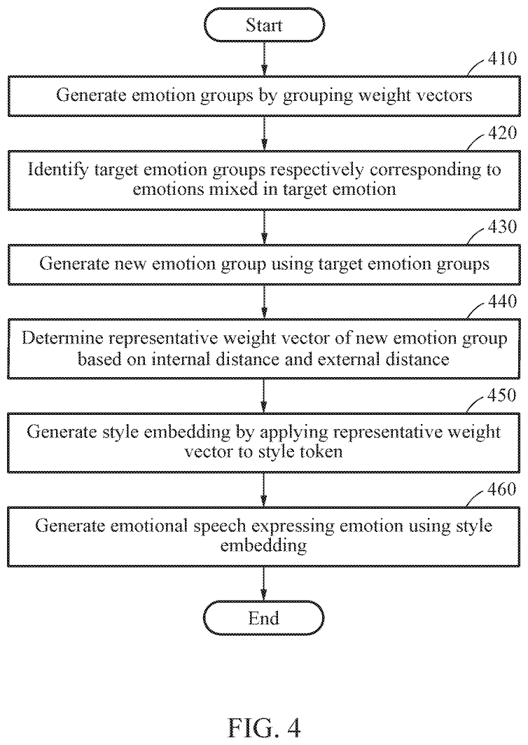

FIG. 4 is a flowchart illustrating an emotional speech generating method according to still another example embodiment. The emotional speech generating method to be described hereinafter according to still another example embodiment may be an emotional speech generating method that expresses a target emotion in which a plurality of emotions is mixed.

Referring to FIG. 4, in operation 410, the emotion vector generator 122 generates emotion groups by grouping weight vectors representing a same emotion into a same emotion group.

In operation 420, the emotion vector generator 122 identifies target emotion groups respectively corresponding to emotions mixed in a target emotion from among the emotion groups. Here, the emotion vector generator 122 may identify, as the target emotion groups, emotion groups respectively corresponding to target emotions from among the emotion groups based on the target emotions input from a user.

In operation 430, the emotion vector generator 122 generates a new emotion group corresponding to the target emotion using the target emotion groups. The emotion vector generator 122 may generate an adjusted emotion group having an adjusted emotional intensity by using a representative weight vector of a neutral emotion group corresponding to a neutral emotion and using one of the target emotion groups. The emotion vector generator 122 may then generate new weight vectors by interpolating weight vectors included in the target emotion groups based on a nonlinear interpolation ratio and applying the adjusted emotion group. The emotion vector generator 122 may then generate the new emotion group by grouping the generated new weight vectors.

In operation 440, the emotion vector generator 122 determines a representative weight vector of the new emotion group based on an internal distance between the weight vectors included in the new emotion group and an external distance between the weight vectors included in the new emotion group and weight vectors included in each of the target emotion groups. For example, a representative weight vector rₑ of a new emotion group e may satisfy Equation 5 below.

$${r}_{e} = arg {max}_{{x}_{k}} \frac{\begin{matrix}α \cdot {\sum }_{x ∈ {X}_{{e}_{s}}} {D}_{E} ( {x}_{k} , {x}_{s} ) + ( 1 - α ) \cdot \\ {\sum }_{x ∈ {X}_{{e}_{i}}} {D}_{E} ( {x}_{k} , {x}_{t} ) + {\sum }_{x ∈ {X}_{{e}_{o}}} {D}_{E} ( {x}_{k} , {x}_{o} )\end{matrix}}{{\sum }_{x ∈ {X}_{e}} {D}_{E} ( {x}_{k} , {x}_{i} )} \qquad [ Equation 5 ]$$

In Equation 5, eₛ denotes a start emotion which is a first emotion among mixed emotions, and eₜ denotes a target emotion which is a second emotion among the mixed emotions. In addition, eₒ denotes another emotion. The new emotion group e may be an emotion group corresponding to a new emotion, for example, depressing sadness and sad anger, instead of a standard emotion such as happiness, sadness, anger, and neutrality.

In operation 450, the emotion vector generator 122 generates a style embedding by applying the representative weight vector of the new emotion group to a style token including prosodic information for expressing an emotion.

In operation 460, the emotional speech generator 123 generates an emotional speech expressing the emotion using the style embedding generated in operation 450.

An emotional speech generating method and apparatus described herein may be written in a program that is executable in a computer and embodied by various recording media such as a magnetic storage medium, an optical readable medium, a digital storage medium, and the like.

According to an example embodiment, it is possible to generate an emotional speech that explicitly expresses an emotion by selecting a representative weight vector for each emotion by measuring an internal distance in a group and an external distance with another group to reflect a characteristic of an emotion group which is a group of weight vectors representing the same emotion, and then by generating a style embedding based on the selected representative weight vector and inputting the generated style embedding to an end-to-end speech synthesis system.

According to an example embodiment, it is possible to control an intensity of a target emotion by generating a new emotion group by linearly interpolating a representative weight vector of a neutral emotion group and a target emotion group, and then by generating a style embedding by selecting a representative weight vector of the new emotion group.

According to an example embodiment, it is possible to express a new emotion used to be absent from given emotion data by generating a new emotion group by linearly interpolating a representative weight vector and another emotion group based on a nonlinear interpolation ratio that is based on a standard deviation between two source emotion groups, and then by generating a style embedding by selecting a representative weight vector of the new emotion group.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. An emotional speech generating method, comprising:
generating emotion groups by grouping weight vectors representing a same emotion into a same emotion group;
determining an internal distance which is a distance between weight vectors included in a same emotion group;
determining an external distance which is a distance between weight vectors included in a same emotion group and weight vectors included in another emotion group;
determining a representative weight vector of each of the emotion groups based on the internal distance and the external distance;
generating a style embedding by applying the representative weight vector to a style token including prosodic information for expressing an emotion; and generating an emotional speech expressing the emotion using the style embedding.

2. The emotional speech generating method of claim 1, wherein the representative weight vector is a weight vector having a smallest sum of internal distances and a greatest sum of external distances among weight vectors included in each of the emotion groups.

3. The emotional speech generating method of claim 1, further comprising:
receiving a text; and
determining a text emotion which is an emotion corresponding to the text by analyzing the text,
wherein the generating of the style embedding comprises:
generating the style embedding using a representative weight vector of a text emotion group corresponding to the text emotion among the emotion groups.

4. An emotional speech generating method, comprising:
generating emotion groups by grouping weight vectors representing a same emotion into a same emotion group;
identifying, from among the emotion groups, a neutral emotion group corresponding to a neutral emotion and a target emotion group corresponding to an emotion to be expressed in an emotional speech;
generating anew emotion group with an emotional intensity adjusted from the target emotion group by using a representative weight vector of the neutral emotion group and the target emotion group;
determining a representative weight vector of the new emotion group based on an internal distance between weight vectors included in the new emotion group, and an external distance between the weight vectors included in the new emotion group and weight vectors included in the neutral emotion group or the target emotion group;
generating a style embedding by applying the representative weight vector of the new emotion group to a style token including prosodic information for expressing an emotion; and
generating the emotional speech expressing the emotion using the style embedding.

5. The emotional speech generating method of claim 4, wherein the generating of the new emotion group comprises:
generating new weight vectors by interpolating, at a nonlinear interpolation ratio, the representative weight vector of the neutral emotion group and the weight vectors included in the target emotion group; and
generating the new emotion group by grouping the generated new weight vectors.

6. The emotional speech generating method of claim 5, further comprising:
receiving a text; and
determining an emotional intensity corresponding to the text by analyzing the text, wherein the generating of the new emotion group comprises:
determining the nonlinear interpolation ratio based on the emotional intensity.

7. The emotional speech generating method of claim 4, wherein the representative weight vector of the neutral emotion group is determined based on an internal distance between the weight vectors included in the neutral emotion group, and an external distance between the weight vectors included in the neutral emotion group and weight vectors included in another emotion group.

8. The emotional speech generating method of claim 7, wherein the representative weight vector of the neutral emotion group is a weight vector having a smallest sum of internal distances and a greatest sum of external distances among the weight vectors included in the neutral emotion group.

9. The emotional speech generating method of claim 4, further comprising:
receiving a text; and
determining a text emotion which is an emotion corresponding to the text by analyzing the text,
wherein the identifying of the target emotion group comprises:
identifying, as the target emotion group, an emotion group representing the text emotion from among the emotion groups.

10. The emotional speech generating method of claim 4, wherein the representative weight vector of the new emotion group is a weight vector having a smallest sum of internal distances and a greatest sum of external distances among the weight vectors included in the new emotion group.

11. A non-transitory computer-readable storage medium storing instructions that, when executed by a processor, cause the processor to perform the emotional speech generating method of claim 1.

12. An emotional speech generating apparatus, comprising:
an emotion vector generator; and
an emotional speech generator,
wherein the emotion vector generator is configured to:
generate emotion groups by grouping weight vectors representing a same emotion into a same emotion group:
identify, from among the emotion groups, a neutral emotion group corresponding to a neutral emotion and a target emotion group corresponding to an emotion to be expressed in an emotional speech;
generate a new emotion group with an emotional intensity adjusted from the target emotion group by using a representative weight vector of the neutral emotion group and the target emotion group;
determine a representative weight vector of the new emotion group based on an internal distance between weight vectors included in the new emotion group, and an external distance between the weight vectors included in the new emotion group and weight vectors included in the neutral emotion group or the target emotion group; and
generate a style embedding by applying the representative weight vector of the new emotion group to a style token including prosodic information for expressing an emotion, and
the emotional speech generator is configured to:
generate an emotional speech expressing the emotion using the style embedding.

13. The emotional speech generating apparatus of claim 12, wherein the emotion vector generator is configured to:
generate new weight vectors by interpolating the representative weight vector of the neutral emotion group and the weight vectors included in the target emotion group based on a nonlinear interpolation ratio; and
generate the new emotion group by grouping the generated new weight vectors.

14. The emotional speech generating apparatus of claim 13, further comprising:
an emotion identifier configured to receive a text, and determine an emotional intensity corresponding to the text by analyzing the text,
wherein the emotion vector generator is configured to determine the nonlinear interpolation ratio based on the determined emotional intensity.

15. The emotional speech generating apparatus of claim 12, wherein the representative weight vector of the neutral emotion group is determined based on an internal distance between the weight vectors included in the neutral emotion group and an external distance between the weight vectors included in the neutral emotion group and weight vectors included in another emotion group.
